(19) United States
(12) Patent Application Publication
(10) Pub. No.: US 2004/0164999 A1
(43) Pub. Date: Aug. 26, 2004

(54) Method and apparatus in a data processing system for rendering through multiple clip regions

(75) Inventors: Neal Richard Marion, Georgetown, TX (US); George Francis Ramsay III, Cedar Park, TX (US); James Stanley Tesauro, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/375,836

(22) Filed: Feb. 26, 2003

(51) Int. Cl. G09G 5/00

(52) U.S. Cl. 345/620

(57) ABSTRACT

A method, apparatus and computer instructions for processing graphics data in a graphics adapter for a set of clip areas in a clip region. Trivial rejection is performed on primitives to reject any primitive outside of the set of clip rectangles, wherein a set of identified primitives is formed in which the set of identified primitives contain unrejected primitives. The set of identified primitives is sent to a memory in the graphics adapter as a command stream to form a set of stored commands. A hardware clipper in the graphics adapter is set to an unprocessed clip rectangle within the set of clip rectangles. The set of identified primitives for the unprocessed clip rectangle is processed using the hardware clipper with the set of stored commands in the memory. The setting of the hardware clipper and the rendering of the set of identified primitives is repeated for each unprocessed clip rectangle until all of the clip rectangles in the set of clip rectangles are processed. The set of clip rectangles are processed without requiring resending of the command stream to the graphics adapter for each clip rectangle in the set of clip rectangles.

### BACKGROUND OF THE INVENTION

1. Technical Field

The present invention relates generally to an improved data processing system and in particular to a method and apparatus for processing graphics data. Still more particularly, the present invention relates to a method and apparatus for rendering graphics data using multiple clip regions.

2. Description of Related Art

Data processing systems, such as personal computers and work stations, are commonly utilized to run computer-aided design (CAD) applications, computer-aided manufacturing (CAM) applications, and computer-aided software engineering (CASE) tools. Engineers, scientists, technicians, and others employ these applications daily. These applications involve complex calculations, such as finite element analysis, to model stress in structures. Other applications include chemical or molecular modeling applications. CAD/CAM/CASE applications are normally graphics intensive in terms of the information relayed to the user. Data processing system users may employ other graphics intensive applications, such as desktop publishing applications. Generally, users of these applications require and demand that the data processing systems be able to provide extremely fast graphics information.

The processing of a graphics data stream to provide a graphical display on a video display terminal requires an extremely fast graphics system to provide a display with a rapid response. In these types of graphics systems, primitives are received for processing and display. A primitive is a graphics element that is used as a building block for creating images, such as, for example, a point, a line, an arc, a cone, or a sphere. A primitive is defined by a group of one or more vertices. An attribute is used to define how a primitive will be displayed. Attributes include, for example, line style, color, and surface texture. A vertex defines a point, an end point of an edge, or a corner of a polygon where two edges meet. Data also is associated with a vertex in which the data includes information, such as positional coordinates, colors, normals, and texture coordinates. Commands are sent to the graphics system to define how the primitives and other data should be processed for display.

With the large amounts of data and computations involved in processing graphics data, especially with three-dimensional applications, many of these computations have been offloaded from the central processing units to a graphics adapter. Within these graphics systems, a graphics pipeline located in the graphics adapter is used to process this graphics data. With a pipeline, the graphics data processing is partitioned into stages of processing elements in which processing of data may be executed sequentially by separate processing elements.

Within these processing elements, a clipping function is typically implemented in which pixels for a primitive located within a clip rectangle are rendered, while pixels for the primitive outside of the clip rectangle are not rendered. The hardware implementing the clipping function is often referred to as a hardware clipper. Often, more than one clip rectangle is used to render the correct pixels on a display. With some high-end graphics adapters, multiple hardware clippers are present to clip graphics primitives. Clipping primitives, such as lines and segments, is faster using hardware clippers, rather than software clippers. Increasing the number of hardware clippers, however, increases the cost of the graphics hardware. Many graphics adapters contain only one hardware clipper because it is easier and cheaper to design and manufacture a graphics chip without multiple hardware clippers. In these types of adapters, the task of complex clipping in which multiple clip rectangles are required is left to graphics software. Although using software clippers will render the desired result, performance is degraded.

Therefore, it would be advantageous to have an improved method and apparatus for rendering pixels through multiple clip rectangles.

### SUMMARY OF THE INVENTION

The present invention provides a method, apparatus and computer instructions for processing graphics data in a graphics adapter for a set of clip rectangles. Trivial rejection is performed on primitives to reject any primitive outside of the set of clip rectangles, wherein a set of identified primitives are formed in which the set of identified primitives are unrejected primitives. The set of identified primitives is sent to a memory in the graphics adapter as a command stream to form a set of stored commands. A hardware clipper in the graphics adapter is set to an unprocessed clip rectangle within the set of clip rectangles. The set of identified primitives for the unprocessed clip rectangle is processed using the hardware clipper with the set of stored commands in the memory. The setting of the hardware clipper and the rendering of the set of identified primitives is repeated for each unprocessed clip rectangle until all of the clip rectangles in the set of clip rectangles are processed. The set of clip rectangles are processed without requiring resending of the command stream to the graphics adapter for each clip rectangle in the set of clip rectangles.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in accordance with a preferred embodiment of the present invention;

FIGS. 3A and 3B are diagrams illustrating clipping using clip rectangles in accordance with a preferred embodiment of the present invention;

FIG. 4 is a diagram illustrating components used to render through multiple clip regions in accordance with a preferred embodiment of the present invention;

FIG. 5 is a flowchart of a process used to render primitives through multiple clip areas in accordance with a preferred embodiment of the present invention; and

FIGS. 6A and 6B are diagrams illustrating example code for rendering primitives for multiple clip areas in accordance with a preferred embodiment of the present invention.

### DETAILED DESCRIPTION OF THE PREFERRED EMBODIMENT

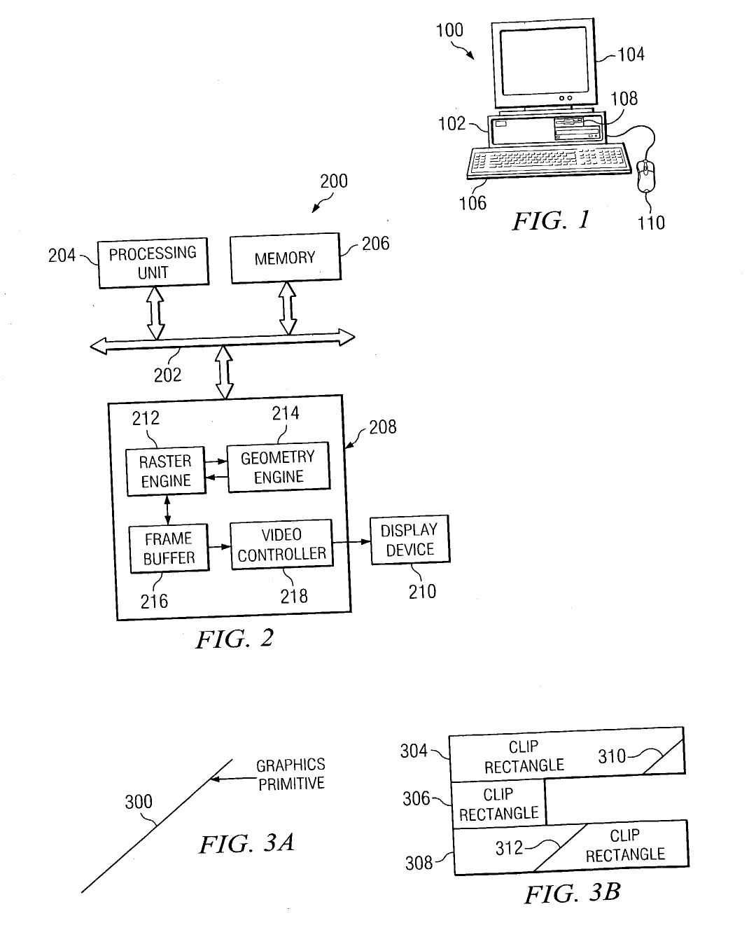

With reference now to the figures and in particular with reference to FIG. 1, a pictorial representation of a data processing system in which the present invention may be implemented is depicted in accordance with a preferred embodiment of the present invention. A computer 100 is depicted, which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of software residing in computer readable media in operation within computer 100.

Turning next to FIG. 2, a block diagram of a data processing system is depicted in accordance with a preferred embodiment of the present invention. Data processing system 200 is an example of components used in a data processing system, such as computer 100 in FIG. 1. Data processing system 200 employs a bus 202 in the form of a peripheral component interconnect (PCI) local bus architecture. Although the depicted example employs a PCI bus, other bus architectures, such as Accelerated Graphics Port (AGP) and Industry Standard Architecture (ISA), may be used. In addition, although only a single bus is illustrated, a more complex bus system implementing multiple buses may be used. Processing unit 204, memory 206, and graphics adapter 208 are connected to bus 202 in these examples. Processing unit 204 includes one or more microprocessors in the depicted example.

Graphics adapter 208, in this example, processes graphics data for display on display device 210. The graphics data is received from applications executed by processing unit 204. Graphics adapter 208 includes a raster engine 212, a geometry engine 214, a frame buffer 216, and a video controller 218. Raster engine 212 receives the graphics data from the application. In these examples, raster engine 212 contains the hardware and/or software used to rasterize an image for display. Raster engine 212 is used to turn text and images into a matrix of pixels to form a bitmap for display on a screen. In the depicted example, raster engine 212 sends the received graphics data to geometry engine 214, which provides the functions for processing primitives and other graphics data to generate an image for raster engine 212 to process. The processed data is then passed back to raster engine 212. The mechanisms of the present invention are located in geometry engine 214 in these examples.

Frame buffer 216 is an area of memory used to hold a frame of data. Frame buffer 216 is typically used for screen display and is the size of the maximum image area on the screen. Frame buffer 216 forms a separate memory bank on graphics adapter 208 to hold a bitmap image while it is “painted” on a screen. Video controller 218 takes the data in frame buffer 216 and generates a display on display device 210. Typically, video controller 218 will cycle through frame buffer 216 one scan line at a time.

The depicted example in FIG. 2 is not intended to imply architectural limitations to the mechanisms of the present invention.

Turning next to FIGS. 3A and 3B, diagrams illustrating clipping using clip rectangles are depicted in accordance with a preferred embodiment of the present invention. In FIG. 3A, a primitive 300 in the form of a line is illustrated. Primitive 300 is clipped using a clip region 302 formed by clip rectangles 304, 306, and 308 in these examples. A clip region is also referred to as a clip list. In this example, segment 310 and segment 312 of primitive 300 is present within clip rectangle 304 and clip rectangle 308 in clip region 302. Pixels for segment 310 and segment 312 will be rendered, while the other portions of primitive 300 will not be displayed.

The mechanism of the present invention uses a single hardware clipper to render the final display of primitives by rendering the primitives through each of the clip rectangles. Additionally, only primitives that are to be drawn are sent to the graphics adapter, which limits the amount of data being passed across a bus to the graphics adapter. The identifying of primitives that are to be displayed is performed through a trivial rejection process in which any primitive outside of the clipped rectangles or is not to be displayed are rejected. In addition, primitives that have not been rejected are sent to the graphics adapter memory through the bus connected to the graphics adapter in the form of a command stream that will be recognized by the graphics adapter. Each of the clip rectangles is processed using the commands from command stream stored in the memory without having to have the stored commands be resent across the bus. These features increase performance by reducing the amount of traffic across the bus connected to the graphics adapter.

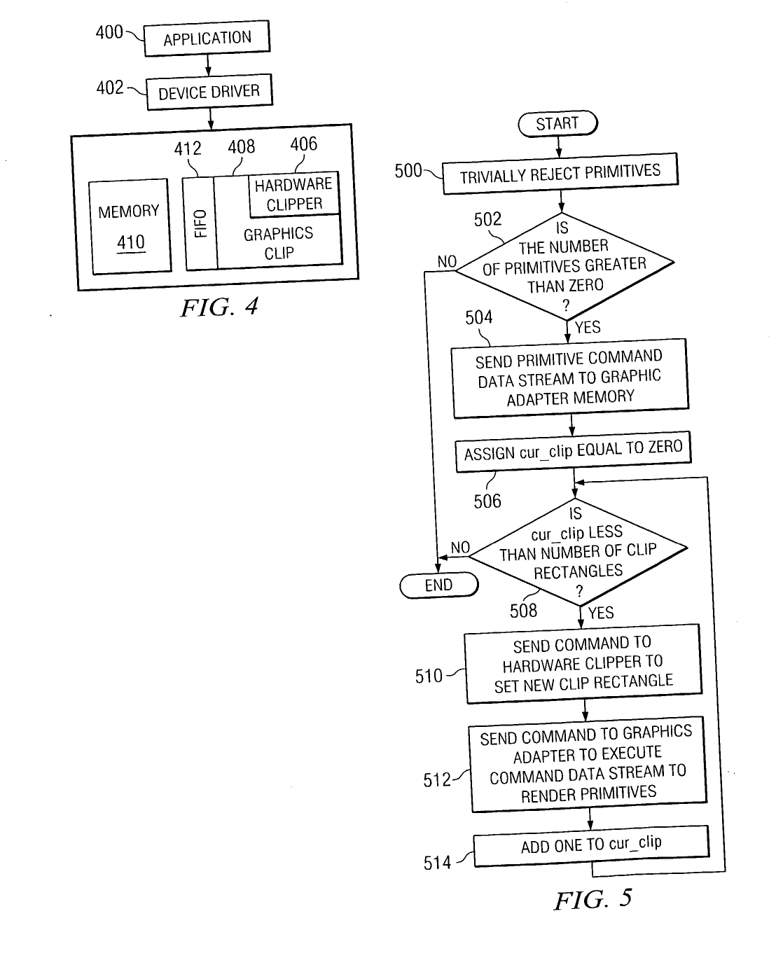

Turning now to FIG. 4, a diagram illustrating components used to render through multiple clip regions is depicted in accordance with a preferred embodiment of the present invention. The components illustrated in FIG. 4 are examples of those that may be found in a data processing system, such as data processing system 200 in FIG. 2. Application 400 and device driver 402 may be found in the form of instructions located in a memory or storage device within data processing system 200 in FIG. 2. Graphics adapter 404 may be implemented as graphics adapter 208 in FIG. 2.

In these examples, clip rectangles or other types of clip areas may be identified by application 400 for a scene or window that is to be rendered for display. These clip rectangles are sent to device driver 402 along with other graphics information, such as primitives for the scene or window. A device driver is a program routine that links a peripheral device to the operating system. A device driver is written by programmers who understand the detailed knowledge of the device's command language and characteristics and contains the precise machine language necessary to perform the functions requested by the application.

In this example, device driver 402 is a graphics device driver used to send graphics data and commands to graphics adapter 404. Device driver 402 will process each of the clip rectangles received from application 400 to identify primitives that will be displayed. Primitives that will be displayed using the set of clip rectangles are sent to a hardware clipper 406 within graphics adapter 404. In this example, hardware clipper 406 is implemented within graphics chip 408. Appropriate commands used to clip the identified primitives for the clip rectangles also are sent. These primitives sent to graphics adapter 404 are sent across a bus, such as a peripheral component interconnect (PCI) bus. The primitives are sent in the form of a command stream recognized by graphics adapter 404 for storage in memory 410.

In these examples, the commands in this command stream are stored in an off-screen portion of memory 410. Any memory with available space within a graphics adapter may be used for storing these commands. For example, off screen memory or utility buffer memory may be used for command data streams. The particular memory used is implementation specific and depends on the particular graphics adapter. In accordance with a preferred embodiment of the present invention, this command stream is sent only once such that the processing of each clip rectangle does not require resending of the command stream.

As mentioned before, clipping is the process of determining the portion lying within a region called a clip region. The clip region is typically either a window on a screen or a view volume. One or more clip rectangles may form a clip region. In these examples, hardware clipper 406 implements a clipping process or algorithm in hardware. More information on clipping processes may be found in Foley, et al. Computer Graphics Principles and Practice, Second Edition, Addison-Wesley Publishing Company, Inc., 1997, ISBN 0-201-84840-6. This process is repeated for each clip rectangle with the primitives being sent to the hardware clipper in graphics adapter 404.

Each time a new clip rectangle is selected for processing, the list of commands in the command stream stored in memory 408 is sent to graphics chip 410 using a memory to memory copy process. These commands are copied in to first-in-first-out buffer 412 for graphics chip 410. In this manner, only a single hardware clipper is required to render or process multiple clip rectangles or areas.

This mechanism avoids the need for software clipping when multiple clip areas or clip rectangles are present and only a single hardware clipper is present in the graphics adapter. Further, this mechanism may be applied to processing multiple clip rectangles when the number of hardware clippers is less than the number of clip rectangles. Additionally, only primitives, which will be drawn, are sent to graphics adapter 404, reducing the amount of data sent across the bus or other communications links to graphics adapter 404.

Further, the command stream used to render the primitives is sent to graphics adapter 404 and stored within memory 408. Previously, this command stream would be sent directly to graphics chip 410 within FIFO 412 in which the commands are discarded as they are processed. With the command stream used to render the primitives being stored in memory 408, traffic across the bus connecting graphics adapter 404 is reduced because commands for the primitives do not have to be resent.

For example, four or five words may typically be sent through the bus to set the hardware clipper and to execute the command stream stored in the graphics adapter stored in memory 404. Previously, a command stream also containing the primitives would have to be resent for each clip rectangle. This prior process could result in thousands of words being sent across the bus for each clip rectangle. In this manner, the present invention improves the performance of clipping graphics primitives and also reduced bus traffic.

Turning now to FIG. 5, a flowchart of a process used to render primitives through multiple clip areas is depicted in accordance with a preferred embodiment of the present invention. This process is implemented in a device driver, such as device driver 402 in FIG. 4, in these examples. Of course, this process may be located in other software components depending on the particular implementation.

The process begins by trivially rejecting primitives (step 500). This step determines whether primitives for the set of clip rectangles may be trivially rejected. In some cases, a primitive may cross a clip region, but may not necessarily be drawn or displayed. Any well known process for trivial rejection may be implemented in step 500. For example, the Cohen-Sutherland Line Clipping Algorithm is an example of one process which may be used for trivially rejecting primitives. If it is clear that the primitive is outside of the clip region or will not be drawn, the primitive is trivially rejected.

After trivially rejecting the primitives for the set of clip rectangles, a determination is made as to whether the number of primitives is greater than zero (step 502). If the number of primitives is greater than zero, a primitive command data stream is sent to the graphics adapter memory (step 504). This command stream contains all of the primitives that are to be processed for the set of clip rectangles. Next, a variable, cur_clip, is set equal to zero (step 506).

A determination is made as to whether the variable, cur_clip, is less than the number of clip rectangles (step 508). If this variable is less than the number of clip rectangles, commands are sent to the hardware clipper to set the hardware clipper to a new clip rectangle (step 510). In this step, the clip rectangle selected is a new one that has not been processed. Commands are then sent to the graphics adapter to execute the command data stream and render primitives for the clip rectangle (step 512). In these two steps, the device driver will send a small number of words to set the clip rectangle and initiate the clipping process, but the commands for the primitives are not resent because they are stored in a memory in the graphics adapter.

Thereafter, the variable cur_clip is incremented by one (step 514) with the process then returning to step 508 as described above. With reference in step 508, if the variable cur_clip is not less than the number of clip rectangles, the process terminates. In this instance, all of the clip rectangles have been processed. Turning back to step 502, if the number of primitives is not greater than zero, the process also terminates because no primitives are present for rendering.

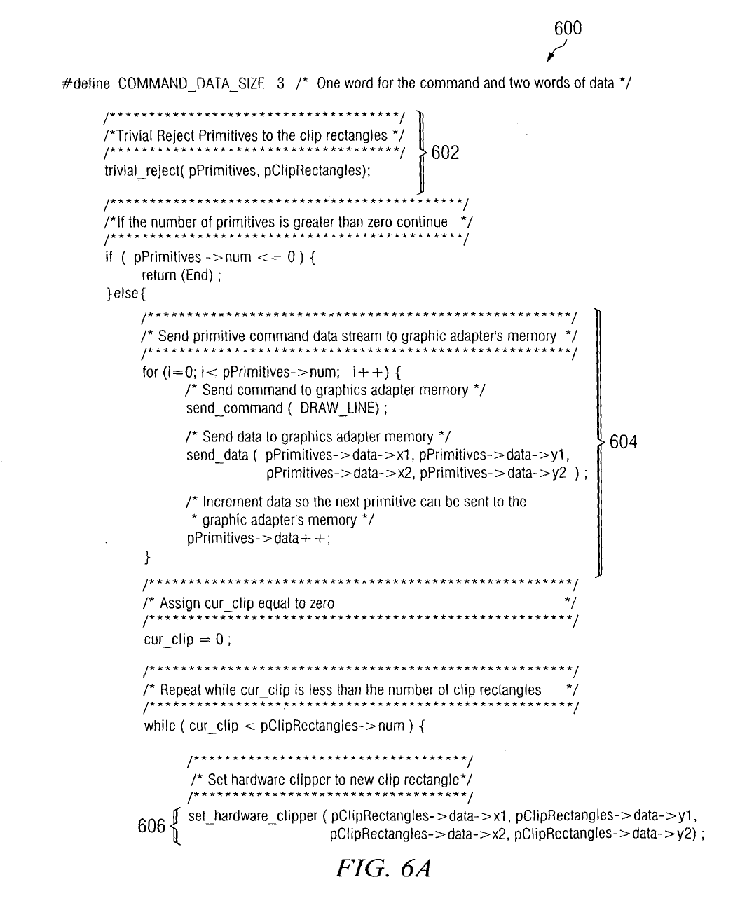

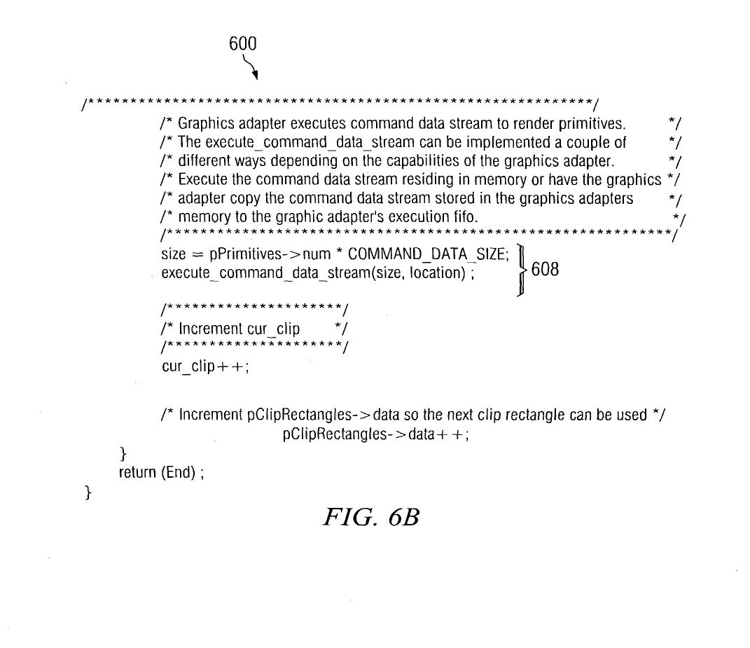

Turning now to FIGS. 6A and 6B, a diagram illustrating example code for rendering primitives for multiple clip areas is depicted in accordance with a preferred embodiment of the present invention. The code illustrated in FIGS. 6A and 6B may be implemented as computer instructions executed by device driver 402 in FIG. 4. Code 600 is an example implementation of the process illustrated in FIG. 5.

In code 600, section 602 in FIG. 6A is employed to initiate a trivial rejection process on the primitives for the clip rectangles. Section 604 contains instructions used to send a primitive command data stream to the graphics adapter memory. In section 606, the instructions are used to set the hardware clipper in the graphics chip to a new clip rectangle. The instructions in section 608 in FIG. 6B are used to initiate execution of commands stored on the adapter to render primitives.

Thus, the mechanism of the present invention provides an improved method, apparatus, and computer instructions for processing graphics data. The amount of data sent across a bus graphics adapter is reduced by trivially rejecting any primitives that lie outside of the clip rectangles or other types of clip areas or will not be displayed. Primitives that have not been trivially rejected are sent across the bus graphics adapter in the form of a command stream that is recognized by the graphics adapter. These commands are stored in memory on the graphics adapter. Each time a clip rectangle is selected, the commands are transferred from the memory to the graphics chip for rendering. In this manner, the commands for the primitives do not have to be resent across the bus for each clip rectangle.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing graphics data in a graphics adapter for a set of clip rectangles, the method comprising:
performing trivial rejection on primitives to reject any primitive outside of the set of clip rectangles, wherein a set of identified primitives is formed in which the set of identified primitives contains unrejected primitives;
sending the set of identified primitives to a memory in the graphics adapter as a command stream to form a set of stored commands in the memory;
setting a hardware clipper in the graphics adapter to an unprocessed clip rectangle within the set of clip rectangles;
rendering the set of identified primitives for the unprocessed clip rectangle using the hardware clipper with the set of stored commands in the memory; and
repeating the setting and rendering steps until all of the clip rectangles in the set of clip rectangles are processed, wherein the set of clip rectangles are processed without requiring resending of the command stream to the graphics adapter for each clip rectangle in the set of clip rectangles.

2. The method of claim 1, wherein the set of identified primitives is sent to the memory in the graphics adapter across a bus and wherein traffic across the bus is reduced.

3. The method of claim 1, wherein performing trivial rejection rejects all primitives, which are not to be displayed.

4. The method of claim 1, wherein the rendering step includes sending the command stream from the memory to a first-in-first-out queue for a graphics chip in the graphics adapter.

5. The method of claim 1, wherein the bus is a PCI bus.

6. A method in a data processing system for processing graphics data in a graphics adapter for a set of clip areas that form a-clip region, the method comprising:
selecting primitives that are to be displayed to form a set of identified primitives;
sending the set of identified primitives to a memory in the graphics adapter in a form of a command stream for processing by a hardware clipper in the graphics adapter; and
processing the primitives for each clip areas in the set of clip areas in the clip region using the hardware clipper, wherein all of the set of clip areas for the clip region are processed in the graphics adapter without requiring resending of the command stream to the graphics adapter.

7. A data processing system for processing graphics data in a graphics adapter for a set of clip rectangles, the data processing system comprising:
a bus system;
a first memory connected to the bus system, wherein a set of instructions is stored in the first memory;
a graphics adapter connected to the bus system, wherein the graphics adapter includes a second memory;
a processing unit connected to the bus system, wherein the processing unit executes the set of instructions to perform trivial rejection on primitives to reject any primitive outside of the set of clip rectangles in which a set of identified primitives are formed in which the set of identified primitives are unrejected primitives; send the set of identified primitives to a memory in the graphics adapter to as a command stream to form a set of stored commands in the first memory; set a hardware clipper in the graphics adapter to an unprocessed clip rectangle within the set of clip rectangles; render the set of identified primitives for the unprocessed clip rectangle using the hardware clipper with the set of stored commands in the memory; and repeat steps used to set clip rectangles and render the set of identified primitives until all of the clip rectangles in the set of clip rectangles are processed, wherein the set of clip rectangles are processed without requiring resending of the command stream to the graphics adapter for each clip rectangle in the set of clip rectangles.

8. A data processing system for processing graphics data in a graphics adapter for a set of clip rectangles, the data processing system comprising:
performing means for performing trivial rejection on primitives to reject any primitive outside of the set of clip rectangle, wherein a set of identified primitives are formed in which the set of identified primitives contains unrejected primitives;
sending means for sending the set of identified primitives to a memory in the graphics adapter as a command stream to form a set of stored commands in the memory;
setting means for setting a hardware clipper in the graphics adapter to an unprocessed clip rectangle within the set of clip rectangles;
rendering means for rendering the set of identified primitives for the unprocessed clip rectangle using the hardware clipper with the set of stored commands in the memory; and
repeating means for repeating initiation of the sending means and the rendering means until all of the clip rectangles in the set of clip rectangles are processed, wherein the set of clip rectangles are processed without requiring resending of the command stream to the graphics adapter for each clip rectangle in the set of clip rectangles.

9. The data processing system of claim 8, wherein the set of identified primitives is sent to the memory in the graphics adapter across a bus and wherein traffic across the bus is reduced.

10. The data processing system of claim 8, wherein performing trivial rejection rejects all primitives, which are not to be displayed.

11. The data processing system of claim 8, wherein the rendering step includes sending the command stream from the memory to a first-in-first-out queue for a graphics chip in the graphics adapter.

12. The data processing system of claim 8, wherein the bus is a PCI bus.

13. A data processing system for processing graphics data in a graphics adapter for a set of clip areas that form a clip region, the data processing system comprising:
selecting means for selecting primitives that are to be displayed to form a set of identified primitives;
sending means for sending the set of identified primitives to a memory in the graphics adapter in a form of a command stream for processing by a hardware clipper in the graphics adapter; and
processing means for processing the primitives for each clip areas in the set of clip areas in the clip region using the hardware clipper, wherein all of the set of clip areas for the clip region are processed in the graphics adapter without requiring resending of the command stream to the graphics adapter.

14. A computer program product in a computer readable medium for processing graphics data in a graphics adapter for a set of clip areas in a clip region, the computer program product comprising:
first instructions for performing trivial rejection on primitives to reject any primitive outside of the set of clip rectangle, wherein a set of identified primitives is formed in which the set of identified primitives contains unrejected primitives;
second instructions for sending the set of identified primitives to a memory in the graphics adapter as a command stream to form a set of stored commands in the memory;
third instructions for setting a hardware clipper in the graphics adapter to an unprocessed clip rectangle within the set of clip rectangles;
fourth instructions for rendering the set of identified primitives for the unprocessed clip rectangle using the hardware clipper with the set of stored commands in the memory; and
fifth instructions for repeating the setting and rendering steps until all of the clip rectangles in the set of clip rectangles are processed, wherein the set of clip rectangles are processed without requiring resending of the command stream to the graphics adapter for each clip rectangle in the set of clip rectangles.

15. A computer program product in a computer readable medium for processing graphics data in a graphics adapter for a set of clip areas that form a clip region, the computer program product comprising:
first instructions for selecting primitives that are to be displayed to form a set of identified primitives;
second instructions for sending the set of identified primitives to a memory in the graphics adapter in a form of a command stream for processing by a hardware clipper in the graphics adapter; and
third instructions for processing the primitives for each clip areas in the set of clip areas in the clip region using the hardware clipper, wherein all of the set of clip areas for the clip region are processed in the graphics adapter without requiring resending of the command stream to the graphics adapter.

16. The computer program product of claim 15, wherein the set of identified primitives is sent to the memory in the graphics adapter across a bus and wherein traffic across the bus is reduced.

17. The computer program product of claim 15, wherein performing trivial rejection rejects all primitives, which are not to be displayed.

18. The computer program product of claim 15, wherein the rendering step includes sending the command stream from the memory to a first-in-first-out queue for a graphics chip in the graphics adapter.

19. The computer program product of claim 15, wherein the bus is a PCI bus.

20. A computer program product in a computer readable medium for processing graphics data in a graphics adapter for a set of clip areas that form a clip region, the computer program product comprising:
first instructions for selecting primitives that are to be displayed to form a set of identified primitives;
second instructions for sending the set of identified primitives to a memory in the graphics adapter in a form of a command stream for processing by a hardware clipper in the graphics adapter; and
third instructions for processing the primitives for each clip areas in the set of clip areas in the clip region using the hardware clipper, wherein all of the set of clip areas for the clip region are processed in the graphics adapter without requiring resending of the command stream to the graphics adapter.
